(19) United States
(12) Patent Application Publication
(10) Pub. No.: US 2019/0086872 A1
(43) Pub. Date: Mar. 21, 2019

(54) Wristwearable Device With Travel Information Indicators

(71) Applicant: Timex Group USA, Inc., Middlebury, CT (US)

(72) Inventor: Felix Poguntke, Karlsruhe (DE)

(21) Appl. No.: 16/196,203

(22) Filed: Nov. 20, 2018

Related U.S. Application Data
(63) Continuation-in-part of application No. 15/201,992, filed on Jul. 5, 2016, now Pat. No. 10,067,477.
(60) Provisional application No. 62/246,798, filed on Oct. 27, 2015.

(51) Int. Cl. G04B 47/06; G01C 21/20

(52) U.S. Cl. CPC G04B 47/06; G01C 21/20

(57) ABSTRACT

A wristwearable device for displaying travel information using a first travel information indicator and a second travel information indicator. The wristwearable device includes a receiver for receiving, from a transmitting device, next turn information and information associated with the next turn information; a first actuation mechanism, coupled to the first travel information indicator, for rotating the first travel information indicator in at least one of a clockwise and counterclockwise direction; a second actuation mechanism, coupled to the second travel information indicator, for rotating the second travel information indicator in at least one of a clockwise and counterclockwise direction;
a controller, coupled to the receiver and the first and second actuation mechanisms, for causing the first actuation mechanism to rotate the first travel information indicator in at least one of the clockwise and counterclockwise direction based on the next turn information received by the receiver; and causing the second travel indicator to indicate information associated with the next turn information; and wherein the position of the first and second travel information indicators conveys information regarding a travel.

### CROSS-REFERENCE TO RELATED APPLICATION

This application is a continuation in part of application Ser. No. 15/201,992, which itself claims the benefit of U.S. Provisional Patent Application Ser. No. 62/246,798 filed on Oct. 27, 2015. The subject matter of parent patent application Ser. No. 15/201,992 is incorporated herein by reference in its entirety.

### BACKGROUND OF THE INVENTION

The present invention is directed generally to wristwearable devices generally, and in particular, to a wristwearable device for displaying travel information. Methodologies to carry out the objectives and functionality set forth herein are also provided.

Smartphones are known to comprise various functions in addition to simply being used as a telephone. Functionality that comes with the phone, or which may thereafter be downloaded by way of application software (e.g. “apps”), includes global positioning system positioning to obtain positional information using global positioning satellites. For example, a user can easily obtain one's positional information, including route navigation information if desired, by using such software.

However, viewing the smartphone display for such positional, route navigational or other travel related information is not always desirable, convenient or even safe. For example, in the rain or snow it may not be desirable to expose the smartphone to the elements. While carrying packages or heavily dressed, it may not be convenient to take out one's smartphone and begin reviewing such positional, route navigational or other travel related information. And of course, while driving and/or riding a motorized/nonmotorized bike (motorcycle, bicycle or the like) it might not even be safe to start viewing the smartphone, which might result in a distraction.

Navigation devices are known as devices mounted in vehicles but also as mobile devices for several outdoor navigations. For example, mobile phones are equipped with the needed technology to allow navigation in conjunction with a suitable application. These navigation systems guide their users based on information about the next direction change as well as information about the remaining distance until the direction change must be applied. This information e.g. turn left, turn right is often presented to the user on a display or similar in addition to a map and a visualized route. The information about a direction change may be presented to the user verbally by computer-generated voices at certain distance markers of these systems.

The use of wireless communications, such as Bluetooth and other related and known wireless radio transmission technologies have made it possible to provide communication between a smartphone and other wireless devices, such as a wristworn device (e.g. a wristwatch). U.S. Pat. No. 9,001,625, owned by the present assignee is just such an example.

U.S. Publication No. 2012/0316777 also describes a navigation system that includes an electronic timepiece and a cellular phone. As described, the cellular phone is capable of executing GPS positioning and a navigation operation with regard to a travelling direction of a user. The timepiece and the cellular phone are described as including a short-range wireless communication function, such as by Bluetooth. The timepiece displays directional information digitally. A similar device is described in U.S. Publication No. 2014/0011540.

U.S. Publication No. 2002/0141289 also describes that the distance to be covered and/or the remaining distance to the selected destination can be provided. Similarly, U.S. Publication No. US2012/0316777 describes an embodiment wherein “remaining distance” may be provided.

However, as best understood, the known prior art is limited in various respects. For example, the descriptions in Publication Nos. 2012/0316777 and 2014/0011540 are limited to wristworn timepieces of the digital type. Other deficiencies, such as a lack of a description of a wristworn analog device receiving instructions and travel information from a mobile device, such as smartphone or the like, are also present in the prior art.

It is thus believed that further advances to the state of the art are both desirable and achievable. For example and not limitation, it is desirable to provide a wristwearable device for displaying travel information and upcoming notice and notifications thereof, such as those associated with next turn information as but one example, wherein the wristwearable device indicates information associated with the next turn information, such as distance and/or time remaining until the next turn.

### SUMMARY AND OBJECTIVES OF THE INVENTION

It is thus an objective of the present invention to overcome the perceived deficiencies in the prior art.

For example, it is an objective of the present invention to provide an improved wearable device of the analog type that can communicate with a transmitting device, such as but not necessarily, a smartphone, other GPS device and/or earth orbiting satellites, wherein both next turn information and information associated with the next turn information are provided using analog type travel information indicators.

It is also an objective of the present invention that the wristwearable device be able to coincidently display more than one travel information, wherein each/any of the travel information can include for example and not limitation, next turn information, direction heading information, remaining distance to a selected destination, distance traveled from a selected destination, travel time since leaving a selected destination, remaining estimated time to a selected destination, distance to a next turn and/or estimated time to a next turn.

It is also a particular objective of the present invention that the wristwearable device be able to display two or more of the aforementioned types of travel information, preferably coincidently, and more preferably, wherein one travel information parameter, such as remaining distance or estimated time prior to a next turn, is displayed and conveyed to the user coincidently with displaying the next turn information.

It is a further objective of the present invention to provide a transmitting device that can carry out and/or facilitate the foregoing objectives.

Yet a further objective of the present invention to provide an application that can be downloaded to the transmitting device for carrying out and/or facilitating the foregoing objectives.

Still a further objective of the present invention is to provide methodologies for carrying out and/or facilitating the foregoing.

Further objects and advantages of this invention will become more apparent from a consideration of the drawings and ensuing description.

The invention accordingly comprises the features of construction, combination of elements, arrangement of parts and sequence of steps which will be exemplified in the construction, illustration and description hereinafter set forth, and the scope of the invention will be indicated in the claims.

Therefore, to overcome the perceived deficiencies in the prior art and to achieve the objects and advantages set forth above and below, a preferred embodiment of the present invention is, generally speaking, directed to a wristwearable device for displaying travel information using a first travel information indicator and a second travel information indicator, the wristwearable device comprising a receiver for receiving, from a transmitting device, next turn information and information associated with the next turn information; a first actuation mechanism, coupled to the first travel information indicator, for rotating the first travel information indicator in at least one of a clockwise and counterclockwise direction; a second actuation mechanism, coupled to the second travel information indicator, for rotating the second travel information indicator in at least one of a clockwise and counterclockwise direction; a controller, coupled to the receiver and the first and second actuation mechanisms, for causing the first actuation mechanism to rotate the first travel information indicator in at least one of the clockwise and counterclockwise direction based on the next turn information received by the receiver; and causing the second travel indicator to indicate information associated with the next turn information; and wherein the position of the first and second travel information indicators conveys information regarding a travel.

In another preferred embodiment, the present invention is, generally speaking, directed to a wristwearable device for displaying travel information using a first travel information indicator and a second travel information indicator, the wristwearable device comprising a receiver for receiving, from a transmitting device, first travel information and information associated with the first travel information; a first actuation mechanism, coupled to the first travel information indicator, for rotating the first travel information indicator in at least one of a clockwise and counterclockwise direction; a second actuation mechanism, coupled to the second travel information indicator, for rotating the second travel information indicator in at least one of a clockwise and counterclockwise direction; a controller, coupled to the receiver and the first and second actuation mechanisms, for causing the first actuation mechanism to rotate the first travel information indicator in at least one of the clockwise and counterclockwise direction based on the first travel information received by the receiver; and causing the second travel indicator to indicate information associated with the first travel information; and wherein the position of the first and second travel information indicators conveys information regarding a travel.

In yet another preferred embodiment, the present invention is, generally speaking, directed to a method of displaying travel information on a wristwearable device, wherein the wristwearable device comprises a first travel information indicator and a second travel information indicator, a receiver for receiving, from a transmitting device, next turn information and information associated with the next turn information; a first actuation mechanism for rotating the first travel information indicator in at least one of a clockwise and counterclockwise direction and a second actuation mechanism for rotating the second travel information indicator in at least one of a clockwise and counterclockwise direction; and a controller, coupled to the receiver and the first and second actuation mechanisms, for (i) causing the first actuation mechanism to rotate the first travel information indicator in at least one of the clockwise and counterclockwise direction based on the next turn information received by the receiver; and (ii) causing the second travel indicator to indicate information associated with the next turn information; wherein the method comprises the steps of receiving, from the transmitting device, next turn information and information associated with the next turn information; and displaying, with the first travel information indicator, a next turn and displaying, with the second travel information indicator, information associated with the next turn; wherein the position of the first and second travel information indicators conveys information regarding the next turn.

In a preferred embodiment, any of the wristwearable devices disclosed herein is a timepiece in the form of a wristwatch.

### BRIEF DESCRIPTION OF THE DRAWINGS

The above set forth and other features of the invention are made more apparent in the ensuing Description of the Preferred Embodiments when read in conjunction with the attached Drawings, wherein:

FIG. 1 is a general overall illustration of a wristwearable device, which is preferably a wristworn timepiece, generally indicated at 10, and constructed in accordance with the present invention, and a transmitting device, generally indicated at 1000, which is preferably, but not necessarily, a smartphone;

FIG. 2 illustrates the construction of an exemplary wristwearable device constructed in accordance with preferred embodiments of the present invention;

FIG. 3 is a perspective view of exemplary gearing and motors in a movement assembly for a wristwearable device constructed in accordance with preferred embodiments;

FIGS. 4-6 are block diagrams showing among other things, a controller for use in a wristwearable device constructed in accordance with the preferred embodiments of the present invention;

FIGS. 7A-7Q illustrate exemplary displays for the wristwearable devices disclosed herein and in accordance with the present invention;

FIGS. 8A-8E illustrate exemplary displays for the wristwearable devices disclosed herein and also in accordance with the present invention; and

FIGS. 9A, 9B shows sequences of steps/methodology to carry out features and steps of the present invention.

Identical reference numerals in the figures are intended to indicate like parts, although not every feature in every figure may be called out with a reference numeral.

### DETAILED DESCRIPTION OF THE PREFERRED EMBODIMENTS

Generally speaking, the present invention is directed to a wristwearable device that can display travel information in an analog manner. For example, the present invention may use the information from a navigation (i.e. transmitting) unit and the corresponding application of e.g. the mobile or smartphone to show travel information such as directional or “next turn” information, including but not limited to “turn left,” “turn right,” “go ahead,” “return,” etc. by means of, for example, hands and/or hand combination on the wristwearable device. Preferably, the navigation information is transferred from the smartphone or mobile phone to the wristwearable device. Then the hands or other indicators on the wristwearable device move to show the user the achieved direction information. In such an example, there is no need to take the mobile phone out of its place (pocket or wherever it might be located). In other words, it may not be needed to be held in one's hand. Because the wristwearable device is preferably on the wrist and is usually always oriented but not limited to in one of two ways (e.g. on the left wrist with the 12 o'clock position pointing away from the user, while on the right wrist the same device might have the 12'o'clock position pointing towards the user), the display of travel information, as disclosed herein, is easily achievable.

In a preferred embodiment of the present invention, the travel information disclosed herein may comprise the display of the direction that the user wants to move or drive, or by way of example and not limitation, may be the display of next turn information indicating next turn instructions in a current and/or upcoming travel itinerary. Still further, such travel information may include distance and/or estimated time parameters to a selected destination or to a next turn, as discussed herein. In such embodiments, the travel information is preferably transmitted from the transmitting device to the wristwearable device by a radio connection, e.g. Bluetooth (BT), Bluetooth Low Energy (BLE) or any similar radio signal. For example, by pressing a pusher on the wristwearable device or, alternatively by means of a position sensor in the wristwearable device, the radio transmission is started and the travel information can be transmitted to the wristwearable device. Then the travel information indicator on the watch moves to show the user the achieved (and/or proposed) travel and/or directional information. Preferably, the travel information indicator is driven by independent motors or MEMS, such as those disclosed in U.S. Pat. No. 8,926,465, the subject matter of which is incorporated by reference as if fully set forth herein, and in a preferred embodiment, preferably by bi-directional stepper motors, but uni-directional motors can also be used therefor. As will be discussed herein, with more than one travel information indicator, preferred embodiments provide that each travel information indicator has its own actuation mechanism (e.g. stepper motor or MEMS) associated therewith, although other configurations as would be understood in the art are achievable.

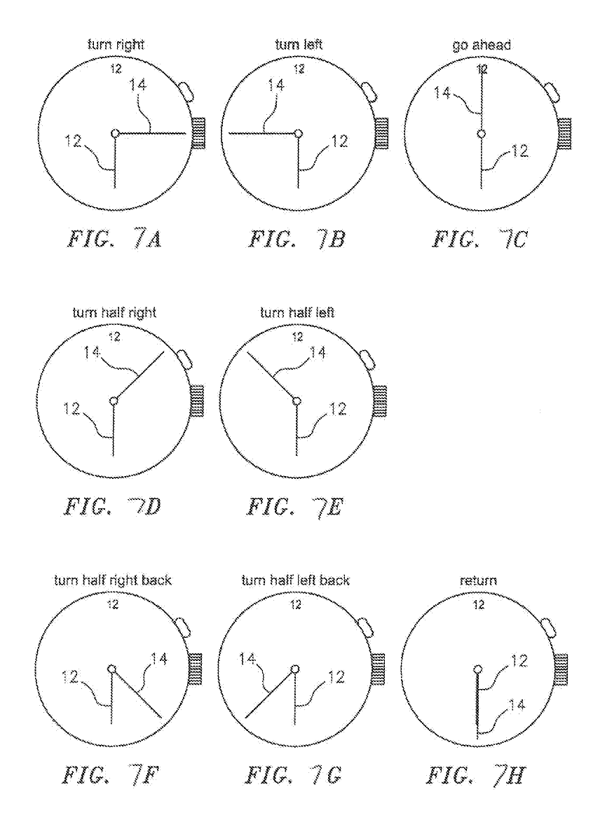

In one embodiment, the “12” o'clock position on the watch can be interpreted as the present direction the user is moving, meaning if the watch is held with the “12” o'clock position ahead, the travel information indicator(s) on the watch may point forwards/ahead or to the right or to the left for to indicate the next needed direction change for the user to be performed on the way to her desired destination. However, it should also be understood that the hands may be positioned elsewhere about the display and/or watch dial. For example, as discussed below, the travel information indicator(s) may be positioned at the 4 o'clock and/or 10 o'clock positions as desired. So, reference to a “12” o'clock position may merely be meant to be an “up” or “north” or otherwise, as the case may be. For example, indicator 22 shown in FIG. 6 is pointing to the “12 o'clock” position for purposes of explanation and understanding of the invention. Thus, the indicators disclosed and claimed herein can be positioned at various locations about the display and/or dial and the illustrations and positions provided herein are for exemplary purposes only.

Preferably the travel information indicator(s) can also function as the minute and/or hour hands when in a time-telling mode, but additional hands and/or other (e.g. dedicated) travel information indicators, as discussed herein, can be provided and used for the navigation information.

As will also be discussed further herein, in addition to the direction change (e.g. next turn information), the travel information indicators disclosed herein can be used to display other parameters and information, including but not limited to, direction heading information, remaining distance to a selected destination or a next turn, distance traveled from a selected destination, travel time since leaving a selected destination and/or remaining estimated time to a selected destination or a next turn. Preferably, multiple travel information is displayed together at the same time on the display, thereby enhancing the display and information being provided to the user.

Thus, it can be seen that in accordance with a first embodiment of the present invention, the wristwearable device may be a timepiece having the configuration and/or incorporating functionality as set forth in the figures herein and/or in the documents incorporated by reference herein. The wristwearable device may be a timepiece such as a wristwatch, and thus may comprise other features and parts, as would be understood by those skilled in the art and/or disclosed in the references cited herein.

For example, many details applicable to the present invention may be found in coowned U.S. Pat. No. 7,113,450 (“Wearable Electronic Device With Multiple Display Functionality”); U.S. Pat. No. 7,027,362 (“Multifunctional Rotating Ring in a Timepiece”); U.S. Pat. No. 7,120,091 (“Electronic Device with Calendar Function”); U.S. Pat. No. 7,821,878 (“Wearable Electronic Device with Multiple Display Functionality”) and U.S. Pat. No. 7,072,246 (“Wearable Electronic Device With Multiple Ring Indicia Display”), the subject matter of all of which are fully incorporated by reference as if each one were fully set forth herein. The present disclosure omits, for purposes of brevity, certain basic and very well-known concepts regarding the construction of analog timepieces. For example, the basic construction and arrangements of gears and/or gear trains to rotate a plurality of “standard” hands all supported on a center stem, but not limited to, such as an hour hand, a minute hand and a “seconds” hand, are omitted as being well within the purview of one skilled in the art, as are details for ring rotations. Likewise, certain known constructions and arrangements of gears and/or gear trains to design a watch will likewise be omitted as being well within the purview of one skilled in the art, although again, such details can be found, for example, in the documents incorporated by reference herein.

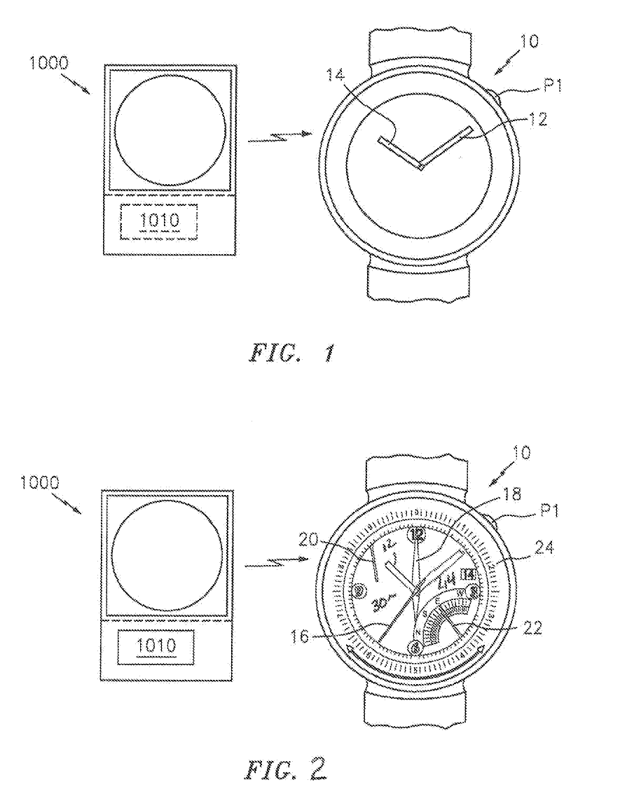

Turning now to additional specifies of the present invention, reference is first made to FIG. 1 which illustrates a general overall illustration of a wristwearable device, which is preferably a wristworn timepiece, generally indicated at 10 and constructed in accordance with a first embodiment of the present invention. Also shown is a transmitting device 1000, which is preferably, but not necessarily, a mobile phone or “smartphone” as would be commonly understood in the art. Alternatively, transmitter 1000 could be a GPS transmitter of any known or hereinafter known type or may be one or more satellites rotating the earth, as would be understood in the art. As noted above, transmitting device 1000 preferably communicates with wristwearable device 10 via Bluetooth or another wireless communication protocol known in the art. A wired tether however, is also contemplated herein for such communication therebetween.

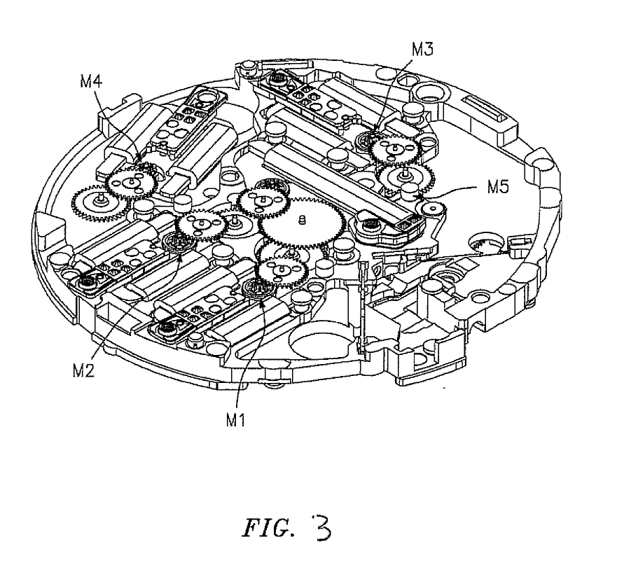

FIG. 2 also illustrates the construction of the exemplary wristwearable device 10 constructed in accordance with preferred embodiments of the present invention. Wristwearable device 10 is of the type wherein information is conveyed in an analog manner at least in part by the use of the travel information indicators. By way of the phrase ‘in an analog manner” for this specific patent application, it is intended to mean displaying such information using one or more travel information indicators, such as a display hand or display ring, which are respectively and operatively coupled to an actuation mechanism, such as a stepper motor or MEMS device as disclosed in the aforementioned U.S. Pat. No. 8,926,465. That is, a mere digital representation of a travel information indicator, such as a display hand or ring, is not deemed to be within the scope of the present invention.

As will be understood in connection with these preferred embodiments, the first travel information indicator is preferably a display hand, such minute hand 12 or hour hand 14. To be sure however, the use of display hands are by way of example and not limitation. For example, instead of a display hand it is possible to use a ring or other type of elongated member such as that disclosed in U.S. Pat. Nos. 7,027,362 and 7,072,246. For example, as illustrated in FIG. 2, a “seconds” hand 16, a “fourth” hand 18 and/or a rotatable ring 24 may be used in lieu of or in addition to the travel information indicators 12, 14 in the manner as disclosed herein. Alternatively, and preferably, hand 16 or hand 18 will function to provide information associated with the first travel information as disclosed more fully below. In a specific embodiment, if/when the first travel information is “next turn information,” hand 16 or hand 18 will function to provide information associated with the next turn information, such as the distance to the next turn or the estimated time to the next turn, or even in yet a further alternative embodiment, height remaining until a next turn (e.g. using an altitude feature), such as if the user was driving/climbing up a hill or mountain, as but one example, and the relative change in elevation (e.g. height) was/is being used as the notification of when the change was needed or upcoming.

A linear indicator, such as that disclosed and claimed in U.S. Pat. No. 7,515,508 the subject matter of which is also incorporated by reference as if fully set forth herein, can also be used in connection with the present invention as well as dedicated indicators 20, 22 if desired.

For example, hand 22 may be used to display “North,” “South,” “East” and West indications, or alternatively, could be used to display minutes/hours to/from a selected destination, using the counter function of U.S. Pat. No. 6,975,562. Still also alternatively, hand 22 or 20 may similarly function to provide information associated with the first travel information as disclosed herein. Again, in a preferred embodiment, if/when the first travel information is “next turn information,” hand 20 or hand 22 may function to provide information associated with the next turn information, such as the distance to the next turn and/or the estimated time to the next turn and/or the height remaining until the next turn.

As illustrated in the figures, wristwearable device 10 is operationally coupleable to transmitting device 1000. By operationally coupleable, it is intended to mean that wristwearable device 10 and transmitting device 1000 communicate with each other via a wired or wireless link. In a preferred embodiment, the operational coupling is wirelessly through a Bluetooth low power radio system as disclosed above, although this is only a preferred embodiment. The design and construction of such a low power radio system would be well known to those skilled in the art.

In a preferred embodiment, transmitting device 1000 comprises hardware and/or software that performs certain functions. For example, transmitting device 1000 is provided with such software and/or hardware (e.g. GPS technology) to obtain all such navigational, positional and other satellite available information as disclosed herein, needed to carry out the disclosed functionality and/or understood in the art. Further, transmitting device 1000 has software and/or hardware to provide for the receipt, calculation, computation, determination and transmission of at least one of (i) the next turn information, direction heading information, remaining distance to a selected destination, distance traveled from a selected destination, travel time since leaving a selected destination, remaining estimated time to a selected destination, distance to a next turn and/or estimated time to a next turn or (ii) data from which the next turn information, direction heading information, remaining distance to a selected destination, distance traveled from a selected destination, travel time since leaving a selected destination, remaining estimated time to a selected destination, distance to a next turn and/or estimated time to a next turn can be derived by the wristwearable device. Transmitting device 1000 is capable of transmitting all of such directional parameters and information and/or data for the derivation thereof. For the avoidance of doubt, transmitting device 1000 may be an iPhone or an Android phone by way of example and not limitation.

Moreover, also for the avoidance of doubt, terms such as “next turn information,” “direction heading information,” “remaining distance to a selected destination,” “distance traveled from a selected destination,” “travel time since leaving a selected destination,” “remaining estimated time to a selected destination,” “distance to a next turn” and/or “estimated time to a next turn” or the like as herein and in the claims is intended to cover both embodiments disclosed above in which the transmitting device 1000 provides for the receipt, calculation, computation, determination and transmission of the (i) the next turn information, direction heading information, remaining distance to a selected destination, distance traveled from a selected destination, travel time since leaving a selected destination, remaining estimated time to a selected destination, distance to a next turn and/or estimated time to a next turn all to the wristwearable device and/or in which (ii) data from which the next turn information, direction heading information, remaining distance to a selected destination, distance traveled from a selected destination, travel time since leaving a selected destination, remaining estimated time to a selected destination, distance to a next turn and/or estimated time to a next turn can be derived by the wristwearable device. In this way, the invention as claimed covers all manner and variations in which the information and/or data can be transmitted to and processed by the wristwearable device 10.

If the transmitting device 1000 transmits data to the wristwearable device 10 from which the travel information is derivable, it is within the contemplated configuration that the wristwearable device 10 accesses its respective own memory, look up table, etc. to derive the travel (e.g. “turn right”) information. As such, wristwearable device 10 comprises memory or the like to carry out this functionality. Again however, the term “next turn information,” “direction heading information,” “remaining distance to a selected destination,” “distance traveled from a selected destination,” “travel time since leaving a selected destination,” “remaining estimated time to a selected destination,” “distance to a next turn” and/or “estimated time to a next turn” or the like is intended to broadly and generically cover all embodiments disclosed herein.

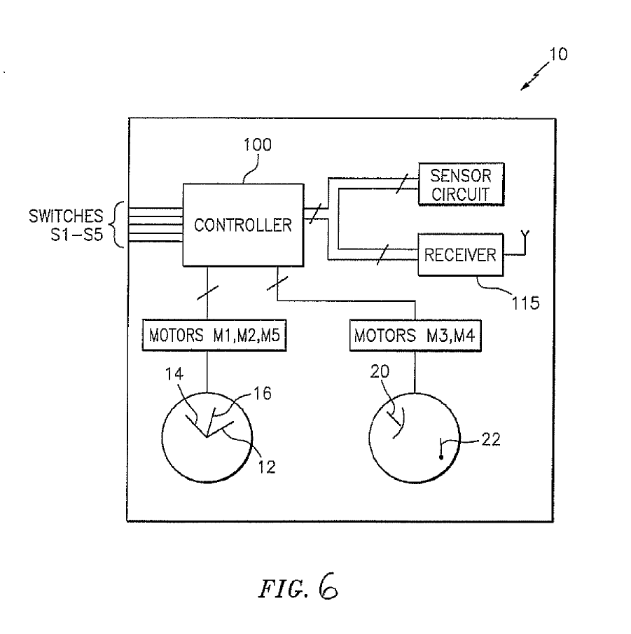

In addition, therefore, in a preferred embodiment, wristwearable device comprises at least a receiver (e.g. receiver 115 in FIGS. 5, 6) for receiving, from the transmitting device 1000, the data indicative of the travel information and/or “next turn information,” “direction heading information,” “remaining distance to a selected destination,” “distance traveled from a selected destination,” “travel time since leaving a selected destination,” “remaining estimated time to a selected destination,” “distance to a next turn” and/or “estimated time to a next turn” or the like, as the case may be.

Reference is thus now also made to FIGS. 2-6 in connection with further details of the present invention. To be sure, many of the details are set forth in the aforementioned U.S. Pat. No. 7,113,450, incorporated by reference here, but out of an abundance of caution, the following is particularly set forth.

In accordance with a preferred embodiment, the wristwearable device further comprises a dial 30 having a dial side and an actuation mechanism side, wherein at least a first travel information indicator, such as hand 12 and/or hand 14, is positioned on the dial side of the dial 30.

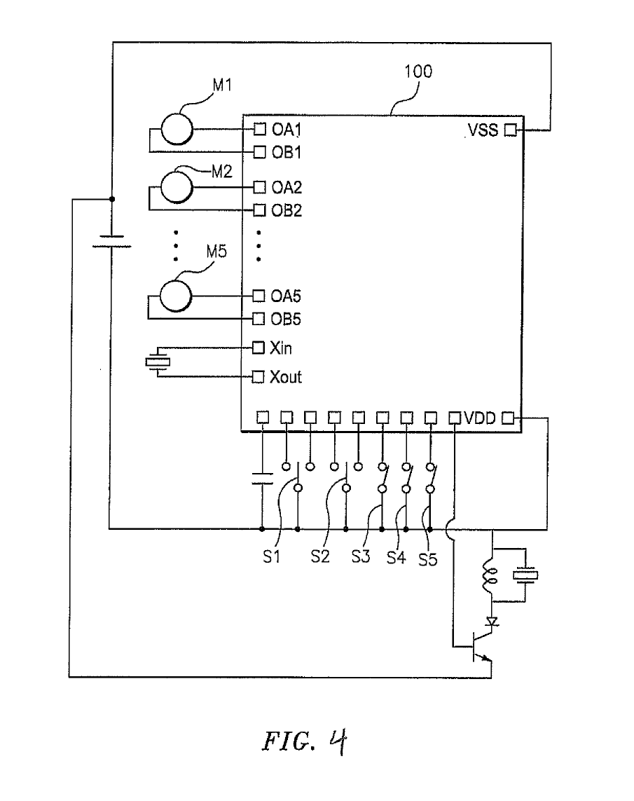

Preferably, wristwearable device 10, in order to carry out all the functionality set forth and/or contemplated herein, is provided with one or more subassemblies, each of which may comprise at least one actuation mechanism and one or more gears rotateably engaged with the actuation mechanism, wherein actuation of the actuation mechanism causes the rotation of the one or more gears. As illustrated in FIG. 3, the preferred actuation mechanisms are stepper motors designated generally as M1, M2, M3, M4 and M5 all of which are disposed in the module of wristwearable device 10. As would be understood in the art, their specific location is one of design choice and dictated by constraints such as spacing, power and torque requirements and the desired positioning of the display hands and/or rings, such as those disclosed in the patents incorporated herein by reference and illustrated herein. As positioned, the respective motors rotate respective pinions (or rings as the case may be), as would be understood in the art and/or after a review of the patents incorporated herein by reference. For the convenience of the reader however, it should be understood that as exemplary illustrated herein, motor M1 is provided to rotate indicator 12, indicator 14 is rotated by stepper motor M2, and respective gear trains are provided to convey the rotational activity generated by the rotor of motor M1, M2 to indicators 12, 14 as would be understood in the art. Likewise, indicators 22 and 20 are each respectively rotated by stepper motors M3 and M4, and respective gear trains may also be provided to convey the rotational activity generated by the respective rotors of motors M3 and M4. The construction of the respective gear trains are well within the purview of one ordinarily skilled in the art.

Motor M5 may be used for hand 16 or hand 18 or another positioned motor could be used therefor, and a respective gear train may be provided to convey the rotational activity generated by the rotor of motor M5 (or a MEMS device as the case may be) as would be understood in the art. As discussed herein, while any of the hands can be used for the claimed “first travel information indicator” and the claimed “second travel information indicator,” it is preferably contemplated that one of the hands 16, 18, 20 or 22 are used for the second travel information indicator while preferably hands 12 and/14 are used for the first travel information indicator. However, those skilled in the art would know and understand how to switch the functionality thereof in view of the present disclosure. In this way, rotation of indicators 12, 14, 16, 20, 22 could be independently controlled, the advantages thereof which will be disclosed below.

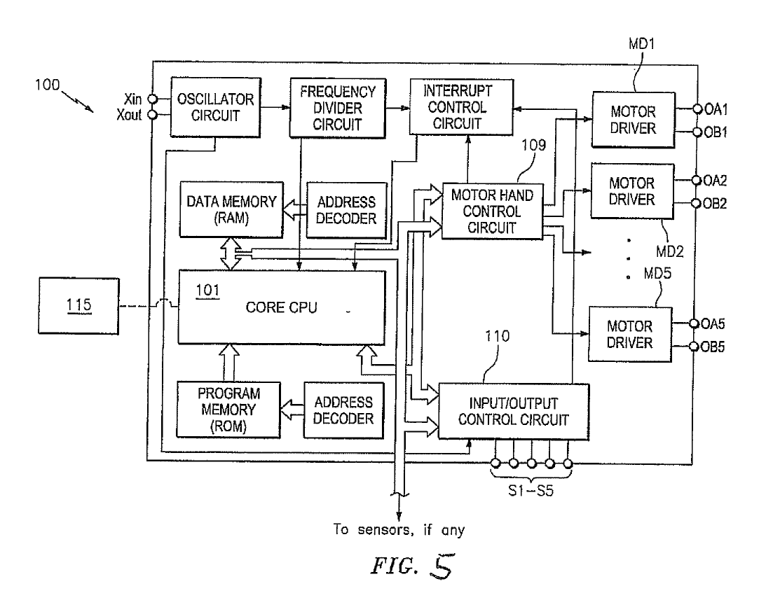

FIGS. 4-6 illustrate many features in accordance with the present invention, including a controller that provides the proper and accurate controlling, positioning and rotation of the one or more travel information indicators and/or any rings. Details of a controller, generally indicated at 100, can likewise be found in many of the aforementioned cited patents (with reference to controller 100 therein), and the controller of the present invention preferably comprises all of the functional features described therein to carry out the objectives and features of the present invention. The added functionality particular to the present invention shall now be disclosed, along with several details to ensure completeness of the disclosure.

For example, FIGS. 4-6 illustrate among other things, interface connections to motors M1, M2, M3, M4 and M5, and pushers, which are illustrated schematically as switches S1-S5. However, it is understood that the switches are also intended to generically indicate both side/top mounted pushers, as well as side mounted rotatable crowns, and thus respond to the actuation (i.e. pulling and/or pushing) action thereof.

FIGS. 5 and 6 illustrate block diagrams that include controller 100. Particular reference is made to motor control circuit 109, which receives a commanded “next number of pulses” from CPU core 101 and generates the pulsed and phased signals necessary to move a desired motor (e.g. M1-M5) a desired amount and in a desired direction. Pulse outputs of motor control circuit 109 are buffered by motor drivers MD1-MD5 and applied to the respective motors M1-M5. An input/output control circuit 110 can controls any crown/stem actuations and/or pushbutton switches S1-S5 and provides such signaling information to CPU 101. The use of the pushers and/or the crown can effectuate a change in operating modes, as would be understood by one skilled in the art.

Controller 100 causes the data and/or information transmitted by the transmitting device to the receiver 115 to be thereafter reflected by the position of the travel information indicators. In view of using a stepper motor and/or MEMS to control the rotation of the travel information indicators, such travel information is displayed in the claimed analog manner by the travel information indicators (e.g. hands 12, 14, 16 and/or 18 as disclosed herein), by causing the rotation of the travel information indicators in at least one of the clockwise and counterclockwise directions as necessary.

Controller 100, preferably knows the position of the rotors for the respective motors M1-M5, and thus causes the respective actuation mechanism(s) to rotate so that the selected travel information indicators and/or the ring, as the case may be, could move or otherwise rotate the appropriate amount. Moreover, the display hand and/or ring calibration methodologies disclosed in the aforementioned patents also assist in ensuring that the hands and/or ring are accurately positioned to display information that is reflected in the analog display of the wristwearable device 10. For such calibration purposes, the methodologies and constructions set forth in U.S. Pat. No. 7,266,051, entitled “Method and Construction for Autocalibrating an Actuation Mechanism,” the subject matter of which is incorporated by reference in its entirety as if fully set forth herein, may be implemented.

That is, as would be understood in the art, the actuation mechanisms, whether they are stepper motors M1, M2, M3, M4 and/or M5 or MEMS devices as disclosed in U.S. Pat. No. 8,926,465, are operatively coupled to the controller 100, wherein the stepper motors step in at least one of a clockwise and counterclockwise direction in predefined increments in response to commands from the controller 100, wherein the stepper motors or MEMS are operatively coupled to the travel information indicators, and wherein the rotation of motors or MEMS causes the rotation of the travel information indicators in at least one of the clockwise and counterclockwise directions and in the predefined increments as disclosed herein.

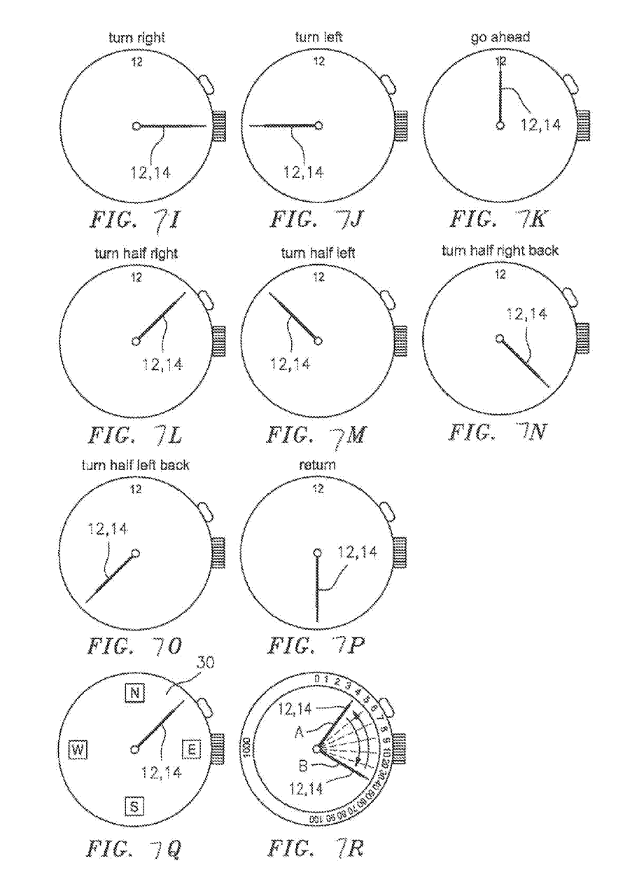

For example, a simple actuation push of pusher P1 or an activation signal of a built-in sensor (e.g. position sensor) or the placing of device 10 is sufficient proximity of transmitting device 1000 would preferably cause the wristwearable device 10 to switch from a “time-telling mode” to a “travel mode,” in which a variety of travel information parameters, such as next turn information, direction heading information, remaining distance to a selected destination, distance traveled from a selected destination, time, travel time since leaving a selected destination, remaining estimated time to a selected destination and/or estimated time and/or distance to a next turn, can be conveyed to a user. For example, and as illustrated in FIGS. 7A-7P once in a travel mode, the wristwearable device 10 could display to the user next turn information, such as “turn right” (FIG. 7A); “turn left” (FIG. 7B); “go ahead” (FIG. 7C); “turn half right” (FIG. 7D); “turn half left” (FIG. 7E); “turn half back right” (FIG. 7F); “turn half back left” (FIG. 7G); and “return” (FIG. 7H). In the foregoing examples, it can be seen that such travel information could be conveyed to the user with only one travel information indicator, e.g. hand 12. Alternatively, two display hands (e.g. minute and hour hands 12, 14) could be used to display similar travel information, such as “turn right” (FIG. 7I); “turn left” (FIG. 7J); “go ahead” (FIG. 7K); “turn half right” (FIG. 7L); “turn half left” (FIG. 7M); “turn half back right” (FIG. 7N); “turn half back left” (FIG. 7O); and “return” (FIG. 7P). In the examples of FIG. 7I through FIG. 7P, it can be seen that it would be preferable that indicators 12 and 14 be independently controlled by separate stepper motors or MEMS device so as to facilitate the rotation thereof independently of what would normally be required if the same hands were linked together in a traditional hour/minute configuration.

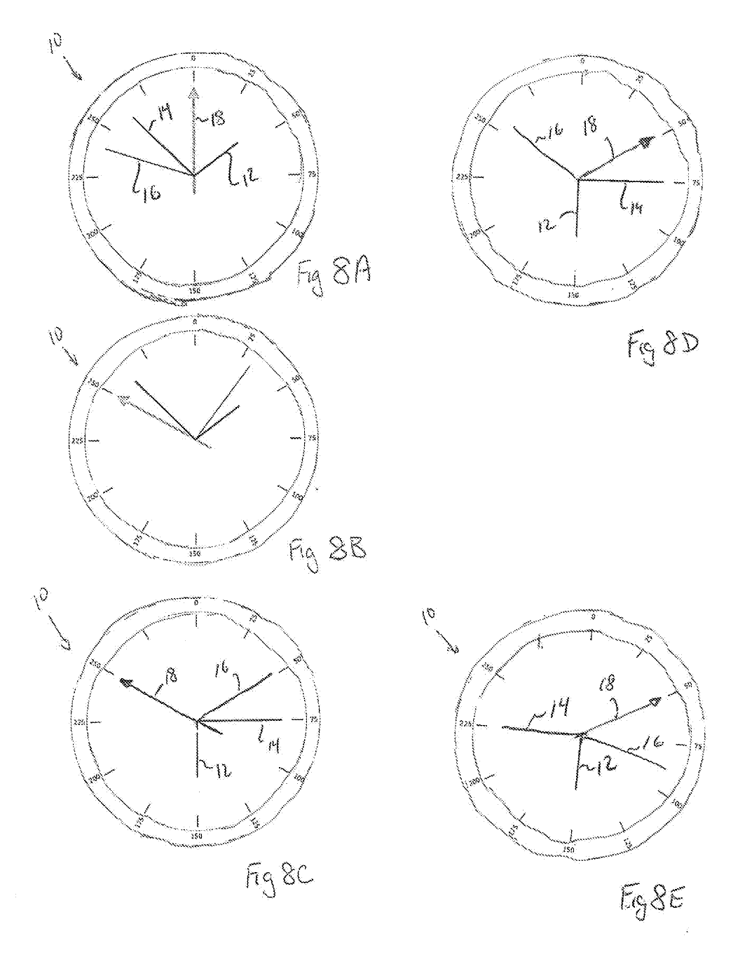

In addition, different scales could be placed on the dial 30, or dedicated hands could be used with printed displays on the dial, or even rotating rings with different scales could be provided (i.e. such as disclosed in U.S. Pat. No. 7,072,246) to provide that the travel information indicator(s) provide for yet additional information on the display of the wristwearable device. For example, direction heading information could be provided (e.g. FIG. 8Q) by use of the travel information indicator(s) 12 and/or 14. In such an example, North/East/South/West indicia could be provided on the dial or could be provided on a rotatable ring underneath the dial 30, with the corresponding indicator pointing to such directional indicia as appropriate. In the example of FIG. 7Q, the indicator(s) 12, 14 are indicating that the user is (or shall next want to be) heading “northeast.” Again, the teachings in the aforementioned patents and/or U.S. Pat. No. 7,120,091 in particular, disclose the use of a rotatable ring in combination with a rotatable hand to convey information in an analog manner.

Moreover, a combination of (i) a travel information indicator 12 and/or 14 for pointing and (ii) a rotatable ring having (one or more scales thereon) i.e. using the functionality U.S. Pat. No. 7,072,246 could provide a rotating (or nonrotating) ring having a plurality of scales thereon, thereby providing enhanced features and facilitating the ability to convey, with one or more additional travel information indicator(s), remaining distance to a selected destination, distance traveled from a selected destination, travel time since leaving a selected destination, remaining estimated time to a selected destination and/or estimated time and/or distance to a next turn. Providing for the appropriate scales and information indicia on the dial (or simply using the time-telling indicia), the travel information indicators could also convey the aforementioned information.

The foregoing features and variations direct the reader to another preferred embodiment of the present invention in which a wristwearable device for displaying travel information using a first travel information indicator and a second travel information indicator, the wristwearable device comprising a receiver for receiving, from a transmitting device, next turn information and information associated with the next turn information; a first actuation mechanism, coupled to the first travel information indicator, for rotating the first travel information indicator in at least one of a clockwise and counterclockwise direction; a second actuation mechanism, coupled to the second travel information indicator, for rotating the second travel information indicator in at least one of a clockwise and counterclockwise direction; a controller, coupled to the receiver and the first and second actuation mechanisms, for causing the first actuation mechanism to rotate the first travel information indicator in at least one of the clockwise and counterclockwise direction based on the next turn information received by the receiver; and causing the second travel indicator to indicate information associated with the next turn information; and wherein the position of the first and second travel information indicators conveys information regarding a travel.

In a broader embodiment, the present invention is directed to a wristwearable device for displaying travel information using a first travel information indicator and a second travel information indicator, the wristwearable device comprising a receiver for receiving, from a transmitting device, first travel information and information associated with the first travel information; a first actuation mechanism, coupled to the first travel information indicator, for rotating the first travel information indicator in at least one of a clockwise and counterclockwise direction; a second actuation mechanism, coupled to the second travel information indicator, for rotating the second travel information indicator in at least one of a clockwise and counterclockwise direction; a controller, coupled to the receiver and the first and second actuation mechanisms, for causing the first actuation mechanism to rotate the first travel information indicator in at least one of the clockwise and counterclockwise direction based on the first travel information received by the receiver; and causing the second travel indicator to indicate information associated with the first travel information; and wherein the position of the first and second travel information indicators conveys information regarding a travel.

For example, as illustrated in FIGS. 8A-8E, a wristwearable device 10 is disclosed for displaying travel information using a first travel information indicator (e.g. 12, 14 and/or 12 and 14) and a second travel information indicator (e.g. FIGS. 8A-8E illustrate the use of hand 18, but hand 16 could be used in place thereof). Receiver 115 similarly receives, from transmitting device 1000, next turn information and information associated with the next turn information. A first actuation mechanism (e.g. motor M1 and/or M2), coupled to the first travel information indicator (e.g. hands 12 and/or 14), rotates the first travel information indicator in at least one of a clockwise and counterclockwise direction. A second actuation mechanism (e.g. motor M5), coupled to the second travel information indicator (e.g. hand 18), rotates the second travel information indicator in at least one of a clockwise and counterclockwise direction. Controller 100, coupled to the receiver 115 and the first and second actuation mechanisms (e.g. M1 and/or M2 in combination with M5), causes the first actuation mechanism to rotate the first travel information indicator in at least one of the clockwise and counterclockwise direction based on the next turn information received by the receiver and causes the second travel indicator to indicate information associated with the next turn information; and wherein the position of the first and second travel information indicators conveys information regarding a travel.

More specifically, FIG. 8A illustrates the device 10 showing the time of day (e.g. 1:57. The moving vector axis through 6:00 and 12:00 of the device 10 represents the moving direction of the wearer. However, in a “travel mode” or at a threshold distance from an upcoming “next turn” for example, hand 18 may rotate to show the remaining distance until a next direction change (e.g. next turn). In the example of FIG. 8B, the displayed distance may be 250 meters. Each change of display can also be optionally combined with an audible/haptic feedback, such as buzzer, sound and/or vibration. Thus, in the case of FIG. 8B, the display illustrates “next direction change (e.g. next turn) in 250 meters.” It is noted that the hands may optionally illustrate “normal time.”

In a more advantageous travel mode, the display of device 10 may move from that shown in FIG. 8A directly to that of FIG. 8C where controller 100 causes the second travel indicator 18 to indicate the information associated with the first travel information coincidently (e.g. at the same time) with the display of the first travel information (e.g. next turn information) as indicated by the position of the first travel indicator 12 and/or 14. For example, as illustrated in FIG. 8C, hands 12 and/14 are indicating that a travel information of a “next turn” (i.e. turn right) occurring in 250 meters (i.e. by hand 18). As such, the term “coincidently” is intended to mean being “coincident,” i.e. occurring together in time. Here, “coincidently” is intended also to mean simultaneously, but only to the extent that both travel information parameters, e.g. the upcoming next turn (e.g. turn right) information and that the turn will be upcoming in 250 meters is displayed at the same time, but the present invention does not require that the hands need to move simultaneously at the exact some moment in time to the respective positions.

With respect to FIG. 8C, it is also contemplated that a sensor system could be incorporated to provide a threshold which leads, combined with the motion of the user, to the display change “normal time” to “turn right,” e.g. threshold value for a user who walks is (e.g.) 15 m, if he is driving by bicycle the threshold value needs to be higher due to his speed and the time he needs to get “prepared” to change direction.

In this way, it can be seen that controller 100 causes the second travel indicator 18 to indicate the information associated with the next turn information (e.g. right hand turn approaching in 250 meters) coincidently with the indication of a next (e.g. right) turn as indicated by the position of the first travel indicator (12 and/or 14). Alternatively, the information associated with the next turn information (as displayed by hand 18) may comprise the estimated time (e.g. 250 seconds, 2.5 minutes, etc.) remaining until the next turn, or even further alternatively, height remaining until a next turn.

To be sure, the travel information conveyed by the first travel information indicator 12 and/or 14 is preferably any one of next turn information, direction heading information, remaining distance to a selected destination, distance traveled from a selected destination, travel time since leaving a selected destination and/or remaining estimated time to a selected destination, while the travel information conveyed by the second travel information indicator 16 and/or 18 is preferably remaining distance and/or time to an upcoming change of direction (e.g. next turn information). However, as stated above, the functions of the indicators could be reversed.

As illustrated in FIG. 8D, the receiver will also preferably receive, from the transmitting device, updated information associated with the next turn; and display, with the second travel information indicator 16 or 18, the updated information associated with the next turn; wherein the position of the first and second travel information indicators conveys updated information regarding the next turn. For example, FIG. 8D illustrates that the updated travel information is that the next turn will be occurring in 50 meters, as indicated by indicator 18. Again, and/or alternatively, indicator 16 or 18 could be indicating 50 seconds to the next turn, etc. As illustrated, the user has been informed that the next turn is upcoming having been previously (e.g.) 250 meters away and now only 50 meters away. Again, the 250 and 50 could represent seconds, minutes, etc. (and/or e.g. feet/meters in an altimeter/altitude mode) if desired.

FIG. 8E illustrates a subsequent next (e.g. left hand) turn in which the receiver receives from the transmitting device subsequent next turn information and information associated with the subsequent next turn information (e.g. an upcoming left hand turn in 50 meters) and the displaying, with the first travel information indicator 12 and/or 14, the subsequent next (e.g. left hand) turn and displaying, with the second travel information indicator 16 or 18, information associated with the subsequent next turn (e.g. upcoming in 50 meters). In this way, the position of the first and second travel information indicators conveys information regarding the subsequent next turn. Here again, the information associated with the next turn information comprises the distance remaining until the next turn and/or the estimated time remaining until the next turn and/or height remaining until the next turn. As discussed above, because the present invention contemplates the ability to provide for different (and/or changing) scales on the bezel, ring or dials in accordance with the multiple disclosures herein, a trip of unlimited distance and/or duration, with turn by turn precision, can be provided and achieved with the present invention using a wristworn device of the analog type.

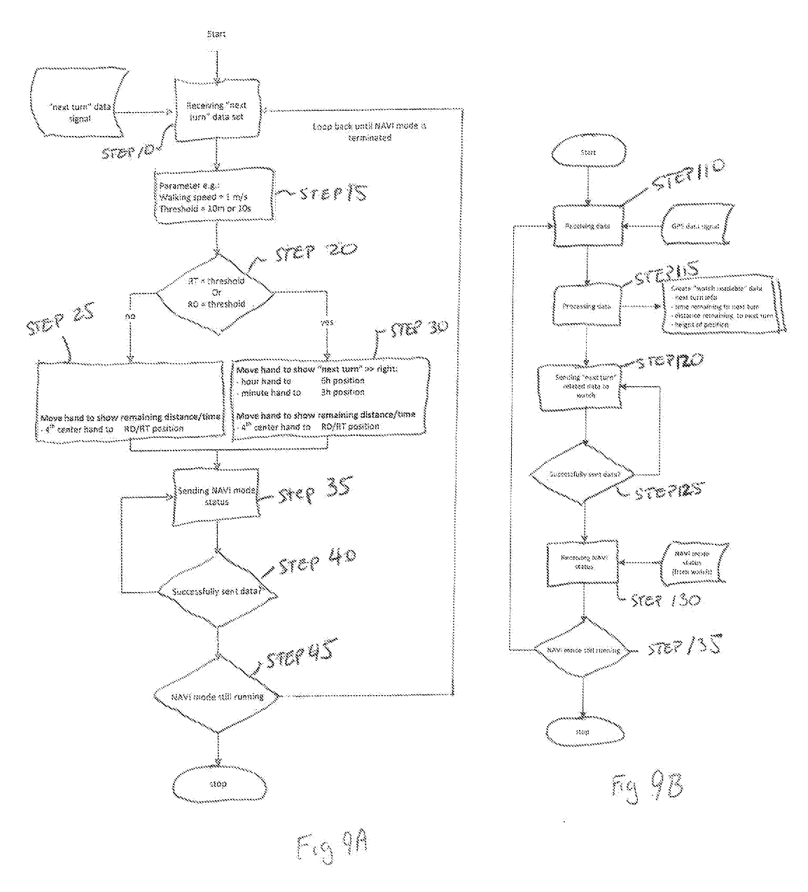

Flowcharts/software programs are provided in FIGS. 9A, 9B that shows a sequence of steps/methodology to carry out features and steps of the present invention. For example, and with reference to FIG. 9A, a sequence begins with the transmitting device sending a “next turn” data set to the wristwearable device (step 10). An exemplary data set would include data indicating that a first travel information (i.e.) next (e.g. right) turn is needed in (e.g.) 250 meters or 250 seconds, as illustrated in FIG. 8C. With the wristwearable device (and/or the transmitting device) maintaining the walking speed of the user and the defining thresholds at which the (e.g.) next turn information and the information associated with the next turn information will be updated (step 15), the program will then determine whether the remaining (i.e. threshold) distance (or time or height) has been reached (step 20). If the remaining distance (or time) has not been reached, (e.g.) hand 18 will be rotated to display the current distance (or time) left before the next turn (e.g. step 25). The methodology/sequence continues to steps 35 where the wristwearable device sends a navigation mode status request to the transmitting device (steps 35, 40). As long as the wristwearable device remains in the navigation (e.g. travel) mode, e.g. step 45, the travel indicators will continue to be updated with the first travel (e.g. next turn) information and the information associated with the travel (e.g. next turn) information. For example, at each decision step 20, as the wristwearable device moves closer in distance or time to the next turn (e.g. 250 meters (or seconds), 200 meters (or seconds) . . . 50 meters (or seconds), etc. (e.g. FIG. 8D), the indicator for indicating information associated with the next turn information (e.g. hand 18) will be updated pursuant to step 25. Once the user (i.e. the wristwearable device) has reached the threshold distance or time, the first travel information indicator (e.g. hand(s) 12 and/or 14) is/are moved to show the next travel (e.g. next turn) information and the second travel indicator (e.g. hand 18) is moved to show remaining distance or time to the next turn (e.g. step 30, i.e. FIG. 8E).

In connection with the foregoing, FIG. 9B illustrates the methodology from the vantage point of the transmitting device. For example, the transmitting device updated receives GPS data from e.g. satellites (step 110), as would be understood in the art. The GPS data is processed at step 115, where the GPS data is processed into “watch readable” data, including for example, next travel ((e.g.) next turn) information and information associated with the travel (e.g. next turn) information, e.g. time and/or distance and/or height remaining until the (i.e.) next turn. At step 120 such processed data is sent to the wristwearable device (e.g. the watch), and the program loops around until the data has been successfully sent (e.g. steps 120, 125). At step 130 the program receives the navigation status of the wristwearable device and if the wristwearable device is still in the navigation mode (as determined at step 135), the methodology loops back to step 110, where the transmitting device receives updated GPS data from e.g. the satellites.

Additional features and advantage are afforded by the present invention. For example, FIG. 7R should be deemed to disclose a wide range of exemplary functions of the present invention. For example, in a first “distance mode” showing distance to a destination, indicators 12, 14 in the “A” position could depict that a user is 4 miles from a destination having previously been 40 miles from said destination (i.e. with the indictors having rotated from position “B” to position “A” over time as appropriate). Similarly, in a second “distance mode” showing distance from a destination, indicators 12, 14 in the “A” position could depict that a user was previously 4 miles from a destination and is now 40 miles from said destination (i.e. with the indicators having rotated from position “A” to position “B” over time as appropriate). Further, in a first “time traveled mode” showing an estimated arrival time to a destination, indicators 12, 14 in the “A” position could depict that a user is currently 4 minutes from a destination having previously been 40 minutes from said destination (i.e. with the indicators having rotated from position “B” to position “A” over time as appropriate). Similarly, in a second “time traveled mode” showing time traveled from a destination, indicators 12, 14 in the “A” position could depict that a user had previously had only traveled 4 minutes from a destination and has now traveled 40 minutes since leaving said destination (i.e. with the indicators having rotated from position “A” to position “B” over time as appropriate).

Controller 100 maintains position information of the rotating ring (e.g. ring 24) and indicators (e.g. 12, 14, 16 and/or 18) so they can work together to convey accurate information. Again, use of the indicators 12 and/or 14 on a traditional dial could also convey the same wide range of information using the hour/minute demarcations as the appropriate scale.

To be sure therefore, the present invention is also directed to an arrangement comprising both the wristwearable device of the type described above and a transmitting device as described above. Moreover, in a preferred embodiment, the data transmitted by the transmitting device is transmitted by the transmitting device over at least one of a wired link and a wireless link and preferably wherein the transmitting device is physically separated from the wristwearable device.

Applicable to all embodiments herein, it is preferable that transmitting device 1000 know of the model and/or type of wristwearable device 10. In this way, transmitting device 1000 includes hardware and/or software that permits the storing of information about the specific wristwearable device or type thereof. For example, such information could be stored in transmitting device 1000 at the time of manufacture, it could be downloaded by the user from, for example, the Internet (in the form of, for example, an “app”) or in another preferred implementation, could be provided to the transmitting device 1000 directly (e.g. downloaded) from the wristwearable device itself. Transmitting device 1000 could also “read” a barcode, QR code or the like on or associated with the device 10 to thus acquire the specifics thereof. In this way, the communication between devices 10, 1000 can be synced up appropriately.

For purposes of adequate disclosure, transmitting device 1000 includes module 1010 which is deemed to represent the needed hardware and software applicable or attributable to the functionality of transmitting device 1000, including but not limited to permitting, causing and effectuating the transmission of data indicative of the travel information disclosed herein to the wristwearable device 10. Presumed to be overinclusive but for the avoidance of doubt, the disclosures of Publication Nos. 2012/0316777 and 2014/0011540 are incorporated herein by reference for such disclosure at the transmitting end, i.e. for the transmitting device 1000. Similarly, U.S. Pat. No. 7,113,450 provides disclosure on how the travel information indicators can rotate based on signals and information transmitted by a transmitting device.

In yet a variation of the foregoing, the dial itself may be an LCD or other type of display (e.g. e-Ink, OLED) in which the informational indicia corresponding to the mode in which the device 10 is operating may be provided thereon. In this implementation, the scales or other “surface” indicia need not be printed or otherwise provided on the dial, but rather the indicia on the LCD could change, thereby providing yet further enhancements in which a single LCD functions both as the dial for normal time-telling yet can change to accommodate all the differing modes in which device 10 can operate.

So, for example, controller 100 could cause the scale of such an LCD display of the wristwearable device 10 to change (e.g.: from 1-10 (e.g. hours) to 1-100 (minutes) or a combination of both (e.g. as in FIG. 7R) or from 1-10 miles to 10-100 miles as the case may be. That is, the data transmitted by the transmitting device 1000 to the wristwearable device 10 could be received by device 10 and cause controller 100 to configure the scale or other surface indicia on the LCD appropriately to more accurately and helpfully guide, or provide information to, the user. Even simple travel information (e.g. “turn right,” “turn left” could be dependent on how the dial is configured using such an LCD display. This feature of changeable scales is particularly advantageous in connection with the display of time and/or distance to the next turn or next travel event, etc.

However, to be sure, what is constant in all of these examples is the use of the travel information indicators 12, 14, 16, 18 or the like are under the control of controller 100 and rotate by an actuation mechanism, preferably a stepper motor or MEMS device.

In the preferred constructions and methodologies, communication between transmitting device 100 and wristwearable device 10 may best be achieved through either Bluetooth or the new Bluetooth Low Energy, both of which are well known in the art, since this allows for device 10 to be compatible with the most number of types of transmitting devices. In the most anticipated constructions, transmitting device may be a “smart phone” as would be understood in the art.

Additionally, the foregoing implementations also may require customized code on transmitting device 1000 for communicating to device 10 (e.g. the watch). Such customizable code could be in the form of an application running on the transmitting device (e.g. an “app.”).

To be sure, the one or more signals and/or any data sent from the transmitting device to the wristwearable device could be initiated by a pusher or a “send” signal or the like on the wristwearable device 10.

The foregoing sequence can be expanded to any number of travel information indicators or rings on wristwearable device 10, and the embodiments in those applications incorporated by reference herein show the wide ranging applicability of the present invention. Particular to the present invention, all that would have to be modified would be the indicators and the controller would have to be modified accordingly. Thus, the present invention provides alternative methods and constructions for simply, intuitively and more easily setting, changing, enabling, disabling and/or selecting features, modes or information as the case may be in a wristwearable device that displays travel information in an “analog” manner (i.e. uses rings and/or hands controller by stepper motors).

In the preferred embodiments, the motors may be bi-directional stepper motors as appropriate, thus being able to rotate in either direction, and the construction of acceptable stepper motors to functionally operate in this manner are widely available and well within the understanding of those skilled in the art. Suitable dials are also well within the purview of the skilled artisan. One skilled in the art would recognize that varying the number of travel information indicators can vary the number of needed stepper motors, all of which is within the scope of the present invention and disclosure and disclosed in those applications incorporated by reference herein.

Although the preferred embodiments provide that controller 100 is highly integrated wherein all timing and display functionality is controlled in controller 100, alternate embodiments could separate the timekeeping functions from those processing and other mode related information, as would be understood by one skilled in the art.

In an alternative embodiment, the functionality of the aforementioned transmitting device may itself be incorporated into the wristwearable device. For this purpose, the figures illustrate an alternative version in which receiver 115 is also provided as e.g. a fully functional receiver device or a distributed receiver arrangement (e.g. a receiver+GPS+any other structure/functionality needed to achieve the functionality of the transmitting device 1000) for the purposes of receiving travel information as disclosed herein. Thus, the receiver may include alternative embodiments to that in which receiver 115 only receives travel information from transmitter 1000.

For completeness, it should thus be understood that in the present invention contemplates that the travel information may be transmitted directly to the wristwearable device from a satellite or cell-tower, by way of examples and not limitation. Thus, and similarly, by pressing a pusher on the wristwearable device or, alternatively by means of a position sensor in the wristwearable device, a radio transmission is started and the travel information can be transmitted to the wristwearable device. Therefore, the receiver 115, whether comprised of a single functional feature or distributed among multiple aspects of software and/or hardware, will perform certain functions. For example, the receiver 115 of this alternative embodiment will be provided with such software and/or hardware (e.g. GPS technology) to obtain all such navigational, positional and other satellite available information as disclosed herein, needed to carry out the disclosed functionality and/or understood in the art, including but not limited to, for the receipt, calculation, computation, determination and transmission of at least one of (i) the next turn information, direction heading information, remaining distance to a selected destination, distance traveled from a selected destination, travel time since leaving a selected destination and/or remaining estimated time to a selected destination and/or (ii) data from which the next turn information, direction heading information, remaining distance to a selected destination, distance traveled from a selected destination, travel time since leaving a selected destination and/or remaining estimated time to a selected destination can be derived by the wristwearable device. Any/all other features and functionality disclosed herein with respect to transmitting device 1000 is also attributable and incorporated into receiver 115 of this alterative embodiment. For example, if the data transmitted to the wristwearable device 10 from which the travel information is to be derived, it is within the contemplated configuration that the wristwearable device 10 accesses its respective own memory, look up table, etc. to derive the travel (e.g. “turn right”) information. As such, wristwearable device 10 comprises memory or the like to carry out this functionality.

In all other respects, the wristwearable device of this alternative embodiment is identical to functions and features of the remaining and/or earlier disclosed embodiments.

As should also be appreciated by one skilled in the art, the location, position and/or size of the travel information indicators are merely dictated, for example, by the position of pinions and the position of the respective subassemblies and thus the illustrations herein are shown by example and not limitation.

The gearing ratio to provide for the desirable display rotation or movement of the travel information indicators or rings is one of design choice depending on the desired or required incremental rotation of the display indicators. Thus the number of wheels in any particular gearing assembly may be more or less than that disclosed herein, and are of design choice for the intended function and based upon a number of criterions known to the ordinary designer. Also, the functionality of the controller can be modified to accommodate the varying embodiments disclosed herein by software-programming techniques or differing controllers, both of which is well within the purview of the skilled artisan.

It can thus be seen that the present invention provides for an improved method and construction for setting, changing, enabling, disabling and/or selecting features, modes or information as the case may be in a wristwearable device, and the present invention provides an improved user interface therefor that is easy to use and which should be welcome to the user over those arrangements in the prior art. For example, as discussed above, using an LCD display the scales and/or other surface indicia indicating time/distance, direction can be changed according to the user's preferences or travel. Moreover, use of the disclosed controller with one or more travel information indicators as disclosed herein can provide for current direction, next traveled direction, upcoming direction, next steps in a travel path, plus both/either time and/or distance to an upcoming direction change, using both a conventional dial or the variations of dials, rings and/or LCD displays as disclosed herein.

More particularly, it can be seen that the present invention provides an improved wearable device of the analog type wherein both next turn information and information associated with the next turn information are provided using analog type travel information indicators.

In addition, the present invention can easily incorporate other advantageous features and functionality. For example and not limitation, sensors, such as an accelerometer, may be provided on/in the wristwearable device for counting steps. Such a sensor, when used in conjunction with an algorithm that takes into account the height and/or stride of the user, can permit the device to calculate distance traveled. Such traveled distance can then further be utilized by the wristwearable device to determine and/or alert the user to the next direction change. Other transmitting/receiving functionality in the wristwearable device would further allow the wristwearable device to communicate with the transmitting device, thus allowing the transmitting device to remain up to date on direction/distance and/or any other travel related information being maintained, calculated and/or displayed by the wristwearable device.

It will thus be seen that the objects set forth above, among those made apparent from the preceding description, are efficiently attained and, since certain changes may be made in the above constructions without departing from the spirit and scope of the invention, it is intended that all matter contained in the above description or shown in the accompanying drawings shall be interpreted as illustrative and not in a limiting sense.

It should also be understood that the following claims are intended to cover all of the generic and specific features of the invention described herein and all statements of the scope of the invention that as a matter of language might fall therebetween.

To be sure, the present invention is applicable to a wide variety of devices and applications. That is, while the following embodiments have been disclosed with reference to particular modes, the scope of the invention is not so limiting.

What is claimed is:

1. A wristwearable device for displaying travel information using a first travel information indicator and a second travel information indicator, the wristwearable device comprising:
a receiver for receiving, from a transmitting device, next turn information and information associated with the next turn information;
a first actuation mechanism, coupled to the first travel information indicator, for rotating the first travel information indicator in at least one of a clockwise and counterclockwise direction;
a second actuation mechanism, coupled to the second travel information indicator, for rotating the second travel information indicator in at least one of a clockwise and counterclockwise direction;
a controller, coupled to the receiver and the first and second actuation mechanisms, for:
causing the first actuation mechanism to rotate the first travel information indicator in at least one of the clockwise and counterclockwise direction based on the next turn information received by the receiver; and
causing the second travel indicator to indicate information associated with the next turn information; and
wherein the position of the first and second travel information indicators conveys information regarding a travel.

2. The wristwearable device as claimed in claim 1, wherein the controller causes the second travel indicator to indicate the information associated with the next turn information coincidently with the indication of a next turn as indicated by the position of the first travel indicator.

3. The wristwearable device as claimed in claim 1, wherein the information associated with the next turn information comprises the distance remaining until the next turn.

4. The wristwearable device as claimed in claim 1, wherein the information associated with the next turn information comprises the estimated time remaining until the next turn.

5. A wristwearable device for displaying travel information using a first travel information indicator and a second travel information indicator, the wristwearable device comprising:
a receiver for receiving, from a transmitting device, first travel information and information associated with the first travel information;
a first actuation mechanism, coupled to the first travel information indicator, for rotating the first travel information indicator in at least one of a clockwise and counterclockwise direction;
a second actuation mechanism, coupled to the second travel information indicator, for rotating the second travel information indicator in at least one of a clockwise and counterclockwise direction;
a controller, coupled to the receiver and the first and second actuation mechanisms, for:
causing the first actuation mechanism to rotate the first travel information indicator in at least one of the clockwise and counterclockwise direction based on the first travel information received by the receiver; and
causing the second travel indicator to indicate information associated with the first travel information; and
wherein the position of the first and second travel information indicators conveys information regarding a travel.

6. The wristwearable device as claimed in claim 5, wherein the controller causes the second travel indicator to indicate the information associated with the first travel information coincidently with the display of the first travel information as indicated by the position of the first travel indicator.

7. The wristwearable device as claimed in claim 5, wherein the travel information conveyed by the first travel information indicator comprises at least one of next turn information, direction heading information, remaining distance to a selected destination, distance traveled from a selected destination, travel time since leaving a selected destination and/or remaining estimated time to a selected destination.

8. The wristwearable device as claimed in claim 5, wherein the travel information transmitted from the transmitting device comprises at least one of (i) the next turn information, direction heading information, remaining distance to a selected destination, distance traveled from a selected destination, travel time since leaving a selected destination, remaining estimated time to a selected destination, distance to a next turn and/or estimated time to a next turn or (ii) data from which the next turn information, direction heading information, remaining distance to a selected destination, distance traveled from a selected destination, travel time since leaving a selected destination, remaining estimated time to a selected destination, distance to a next turn and/or estimated time to a next turn is derivable.

9. A method of displaying travel information on a wristwearable device, wherein the wristwearable device comprises a first travel information indicator and a second travel information indicator, a receiver for receiving, from a transmitting device, next turn information and information associated with the next turn information; a first actuation mechanism for rotating the first travel information indicator in at least one of a clockwise and counterclockwise direction and a second actuation mechanism for rotating the second travel information indicator in at least one of a clockwise and counterclockwise direction; and a controller, coupled to the receiver and the first and second actuation mechanisms, for (i) causing the first actuation mechanism to rotate the first travel information indicator in at least one of the clockwise and counterclockwise direction based on the next turn information received by the receiver; and (ii) causing the second travel indicator to indicate information associated with the next turn information; wherein the method comprises the steps of:
receiving, from the transmitting device, next turn information and information associated with the next turn information; and
displaying, with the first travel information indicator, a next turn and displaying, with the second travel information indicator, information associated with the next turn;
wherein the position of the first and second travel information indicators conveys information regarding the next turn.

10. The method as claimed in claim 9, wherein the displaying of the next turn is coincident with displaying of the information associated with the next turn.

11. The method as claimed in claim 9, comprising the steps of:
receiving, from the transmitting device, updated information associated with the next turn; and
displaying, with the second travel information indicator, the updated information associated with the next turn;
wherein the position of the first and second travel information indicators conveys updated information regarding the next turn.

12. The method as claimed in claim 11, wherein the information associated with the next turn information comprises a first distance remaining until the next turn and the updated information associated with the next turn comprises a second distance remaining until the next turn, wherein the first distance is greater than the second distance.

13. The method as claimed in claim 11, comprising the steps of:
receiving, from the transmitting device, subsequent next turn information and information associated with the subsequent next turn information; and
displaying, with the first travel information indicator, a subsequent next turn and displaying, with the second travel information indicator, information associated with the subsequent next turn;
wherein the position of the first and second travel information indicators conveys information regarding the subsequent next turn.

14. The method as claimed in claim 9, wherein the information associated with the next turn information comprises the distance remaining until the next turn.

15. The method as claimed in claim 9, wherein the information associated with the next turn information comprises the estimated time remaining until the next turn.

16. The wristwearable device as claimed in claim 1, wherein the information associated with the next turn information comprises the estimated height remaining until the next turn.
